(19) United States
(12) Patent Application Publication
(10) Pub. No.: US 2015/0257402 A1
(43) Pub. Date: Sep. 17, 2015

(54) Product And Process For The Production Of Date Syrup-Milk Powder Product

(71) Applicant: United Arab Emirates University, Al Ain (AE)

(72) Inventors: Oya Sipahioglu, Kayseri (TR); Ibrahim Awadelsid, Al Ain (AE); Ismail Abulhalim, Al Ain (AE)

(21) Appl. No.: 14/212,161

(22) Filed: Mar. 14, 2014

(51) Int. Cl. A23C 1/04; A23C 1/16

(52) U.S. Cl. CPC A23C 1/04; A23C 1/16

(57) ABSTRACT

The present invention relates to a process for the preparation of a date syrup-milk powder product composed of date syrup and concentrated milk. The process involves mixing concentrated milk and date syrup at a raised temperature followed by drying the mixture in a spray dryer without using drying agents. The date syrup-milk powder product obtained is 100% natural and highly nutritious, containing nutrients from both milk and dates. The date syrup-milk powder product offers the advantage of being non-sticky easily, dissolved in water, improved flow characteristics and longer shelf life.

### FIELD OF INVENTION

The invention relates to the field of dairy based food products. The invention particularly relates to the production of a date syrup-milk powder product using natural ingredients and its use in food and beverage industries.

### BACKGROUND

Date fruits have been used abundantly in many cuisines around the globe. It finds its use in snacks, as part of the consumables, desserts, confectionaries, sweeteners, vinegar, juices, spreads and so on. Dates have also been used in the form of syrup, also known as date-dibbs in plenty of food and beverage preparations.

The application of date fruit/syrup in the food and beverage industry lies in the fact that date fruit is highly nutritious. Dates are rich in dietary potassium, carbohydrates, proteins, fibre and contain a wide range of trace elements like boron, cobalt, copper, fluorine, magnesium, manganese, selenium, and zinc, all of which are essential for proper nourishment of the body.

There are various known processes for the production of milk powders including spray drying, freeze drying and roller drying. Several attempts have been made to improve the powder characteristics as follows:

U.S. Pat. No. 6,548,099 B1 describes the process of converting the amorphous lactose in dry milk powder to crystalline lactose utilizing emulsifiers like lecithin.
U.S. Pat. No. 4,871,573 claims a process for the preparation of a powdered milk product containing crystalline lactose using lactose crystals as crystallization initiator molecules and includes the addition of disodium hydrogen phosphate dehydrate as a stabilizer.
U.S. Pat. No. 3,278,310 relates to a process of preparing a milk powder containing lecithin. French patent no. 2077611 relates to a process of preparing compact milk powder using milk and externally added sugars.

Also, a wide range of fortified milk powders is available commercially. This fortification is done using minerals and/or using its mineral derivatives. An example of the fortification is available in U.S. Pat. No. 5,397,589. This US patent discloses a method for calcium fortification of a milk product to improve its dispersibility in an aqueous medium. It does so by addressing the lactose crystallization during the spray drying process using calcium salts.

Various flavored milk products are commercially available. However there is no record of an attempt to combine the richness of the date with the nutrition of the milk.

Milk and dates together contain a high quantity of reducing sugars. The sugar content of a ripe date is about 64-67% by weight. Reducing sugars like glucose and fructose account for a majority of the sugars present in dates. One of the major problems encountered during the production of a milk powder is stickiness. Milk contains high levels of low molecular weight sugars like glucose, fructose and lactose (Konuspayeva et al., 2009). Low molecular weight sugars have low glass transition temperatures (Tg) and strong hygroscopicity. The high level of low molecular weight sugars results in the decrease of the Tg of the entire mixture. So during the spray drying process, the product obtained will be sticky in nature and not free flowing (Adhikari et al., 2004 and 2009, and Jayasundera et al., 2011). In order to overcome stickiness, prior art mentions the use of drying agents like maltodextrin, starches, gum and liquid glucose (Chegini et al., 2009) to increase the Tg of the mixture and hence overcome stickiness during the spray drying process.

In recent times, consumers have become more health conscious and the demand for natural food products are on the rise. Also, improved production method is required for preparing milk products to ensure good flowability, non-stickiness and improved shelf life. The present invention helps to meet the growing consumer demand as well as address the problems faced during the spray drying of sugar rich products by preparing a date syrup-milk powder product using only natural ingredients with improved production features.

### SUMMARY OF INVENTION

An object of the invention is to provide a date syrup-milk powder product and a process for the production of the date syrup-milk powder product using concentrated milk and date syrup.

As an aspect of the invention, there is provided a process for the production of the a date syrup-milk powder product comprising the steps of:
a) Mixing the concentrated milk and the date syrup; and
b) Drying the homogenised mixture in a spray dryer.

In a preferred embodiment, the homogenised mixture may be heated prior to drying it in a spray dryer.

Preferably, the concentrated milk and date syrup may be first heated and then mixed to obtain a homogenised mixture.

In yet another preferred embodiment, the concentrated milk and date syrup may be heated during the mixing operation.

The mixture of concentrated milk and date syrup may be heated to a temperature in the range of from about 40° C. to 50° C.

The mixing operation is preferably carried out in an agitated vessel whereas the heating operation is carried out in a jacketed vessel. Preferably, the mixing and the heating operations are carried out simultaneously in the same vessel.

Another aspect of the invention is the production of a date syrup-milk powder product by a process comprising, a) concentrating the milk; b) preparing aqueous extract of dates; c) concentrating aqueous extract of dates; d) mixing the concentrated milk and date syrup; e) heating the mixture of concentrated milk and date syrup; and f) drying the mixture in a spray dryer.

The concentrated milk may be obtained by passing the milk through an evaporator to reduce its moisture content. Preferably, vacuum evaporators are used to concentrate milk. Amongst vacuum evaporators, the rising-film evaporator is preferably used.

The milk used for the concentration process may be selected from a group comprising fresh milk, skimmed milk, semi-skimmed milk, organic milk, filtered milk, whole milk, reconstituted milk, low fat milk and any mixtures thereof. The milk may be obtained from any of the animals selected from cow, camel, goat, sheep, buffalo, donkey, horse, reindeer, and yak. Whole camel milk and whole bovine milk are used for optimum results.

The homogenised mixture may be added into the spray dryer at a feed rate of 3 l/hr to 6 l/hr. Preferably, the homogenised mixture is added into the spray dryer at a feed rate of 4 l/hr.

The temperature of the spray dryer may be maintained at a temperature in the range of from about 130° C. to 160° C., preferably at 140° C.

In an embodiment of the invention, the milk obtained after concentration process has total solids content in the range of from about 15% w/w to 30% w/w. Preferably, the total solids content in concentrated milk is no higher than 20% w/w.

The date syrup may be obtained by concentrating the aqueous extract of dates.

The aqueous extract of dates may be obtained by steeping dates in water.

In another embodiment of the invention, the date syrup obtained after concentration process has total solids content in the range of 65% w/w to 85% w/w. Preferably, the total solids content in date syrup is no higher than 75% w/w.

In a preferred embodiment, the homogenous mixture of concentrated milk and date syrup may be dried in a spray dryer without the aid of any drying agents like malto-dextrose, starch, gums, liquid glucose, corn-syrup and any mixtures thereof.

Another aspect of the invention is the date syrup-milk powder product comprising milk solids and date solids.

In a preferred embodiment, the date syrup-milk powder product has milk solids content in an amount ranging from 35% w/w to 75% w/w, preferably 55% w/w and date solids content in an amount ranging from 25% w/w to 65% w/w, preferably 45% w/w.

The date syrup-milk powder product may be obtained in the form of a powder, particle or a granule.

The date syrup-milk powder product has moisture content ranging from 1.1% v/v to 2.3% v/v, bulk density ranging from 220 kg/m³ to 470 kg/m³, and tapped density ranging from 400 kg/m³ to 600 kg/m³.

In an embodiment, the date syrup-milk powder product further comprises carbohydrates, proteins, vitamins, minerals and trace elements. Sugars like glucose, fructose, and lactose constitute a major proportion of carbohydrates present in the date syrup-milk powder product. The minerals are selected from a group comprising calcium, potassium, magnesium, phosphorus, and zinc along with their organic or inorganic derivatives or both. Iron, copper, manganese and their oxides constitute the trace elements.

In a preferred embodiment, the date syrup-milk powder product contains proteins in an amount ranging from about 12% w/v to 14% w/v and carbohydrates ranging from 8% w/w to 20% w/v.

In a preferred embodiment, the date syrup-milk powder product does not contain any additives. The additives include sweeteners, emulsifiers, preservatives, stabilizers, mineral salts, food colorings, tracer gas, flavor enhancers and drying agents and any mixtures thereof.

The date syrup-milk powder product of the invention may be used either in whole or in part or in the manufacturing process of other consumables in the food and beverage industries.

The date syrup-milk powder product of the invention may be used in the preparation of confectionaries, desserts, food coloring, sweeteners, snacks, ready to eat cereals, bars, meals, baked products, canned products, whitener for beverages (including but not limited to coffee), sauces, food dressings, beverages, instant mixes, energy drinks, soft drinks, energy drinks, liqueur, squashes and mocktails.

### DETAILED DESCRIPTION

According to the broadest aspect, the invention relates to the production of a natural date syrup-milk powder product prepared using concentrated milk and date syrup. The process involves mixing date syrup and concentrated milk at low temperatures followed by drying it in a spray dryer at a pre-determined temperature, so as to obtain the date syrup-milk powder product with good flowability and shelf life.

### DEFINITIONS

The term “Maillard reaction” represents the non enzymatic browning of the mixture components.

The term “bulk density” is defined as the mass of many particles of the material divided by the total volume they occupy. The unit of bulk density is kilogram per cubic meter or kg/m³.

The term “tapped density” refers to the bulk density of the powder or granules after a specific compaction process. The unit of tapped density is kilogram per cubic meter or kg/m³.

The term “angle of repose” refers to the steepest angle of descent or dip of the slope relative to the horizontal plane when material on the slope face is on the verge of sliding. This angle is usually in the range 0°-90°.

The term “glass transition temperature” is defined as the temperature at which the amorphous phase of the polymer is converted into rubbery states. It is denoted by “Tg”.

The term “sticky point temperature” is defined as the temperature at which caking is instantaneous. The sticky point temperature is about 10° C. higher than the glass transition temperature.

The term “stickiness” or “sticky point” defines a property of the substance or particles to cling or stick to one another as well as the surrounding surface. It is defined as the state at a temperature higher than the glass transition temperature where particles become sticky from a rubbery behavior.

The term “non-sticky” defines the property of a substance or particles to remain as discrete particles without cohesion.

The term “flowability” refers to the capability of a loose particulate solid to move by flow.

The term “shelf life” refers to the length of time that a product may be stored without becoming unfit for use or losing some of its qualities.

The term “vessel” refers to a container wherein mixing, heating or stirring operations can be carried out. The vessel can have agitators, stirrers, baffles, heating/cooling jackets depending on the operations carried out inside the vessel.

The term “feed rate” defines a rate at which components/constituents/ingredients are fed into the vessel. The unit of feed rate is liter per hour or l/hr.

The abbreviation “w/w” stands for weight by weight and is defined as the weight of a single constituent divided by the total weight in a mixture. It is generally calculated in terms of percentage.

The abbreviation “w/v” stands for weight by volume and is defined as the weight of a single constituent in a fixed volume of a solution. It is generally calculated in terms of percentage.

The concentrated milk is obtained by passing the milk through an evaporator. This treatment helps reducing the moisture content of milk thereby concentrating it. The evaporator may be selected from a range of different types of evaporators that are available commercially. Examples include falling film evaporators, rising-film evaporators, forced circulation evaporators and wiped film evaporators. Any of these evaporators may be used to achieve the desired milk concentration. However, best results are obtained using rising-film evaporators.

In a preferred embodiment, rising-film evaporator is used for concentrating milk. After the concentration process, the total solid content of the milk is in the range of 15% w/w to 30% w/w. For best results, milk is concentrated so as to obtain the total solids content of up to 20% w/w. The advantage of using the rising-film evaporator is that the milk is concentrated by heating it at a temperature less than the boiling temperature of the milk, preferably at a temperature equal or less than 70° C. and the total time required for concentrating milk is reduced.

The milk required for the concentration process can be obtained from dairy animals like cow, camel, goat, sheep, buffalo, horse, donkey, reindeer and yak. Different types of milk can be used. Examples of which include fresh milk, skimmed milk, semi-skimmed milk, organic milk, filtered milk, whole milk, reconstituted milk, and any mixtures thereof. Preferably whole camel milk is used for carrying out the invention.

Prior to the concentration process, milk is typically stored at a temperature in the range of from about 0° C. and 4° C. The milk may be treated prior to its further processing in an evaporator. The treatment is required for sterilization purposes as well as to increase the shelf life of the milk. Milk is treated by any of the treatment methods comprising heat treatment, pasteurization and filtration and a combination thereof.

Date syrup, also called date-dibbs, may be obtained by concentrating the aqueous extract of dates. The aqueous extract of dates may be obtained by steeping dates in water. The aqueous extract of date is then subjected to series of filtration and centrifugation operations to remove its fibrous content. The extract maybe then concentrated in vacuum evaporators until the desired solid content is achieved. The concentrated extract is hereafter referred to as date syrup or date-dibbs. The date syrup obtained from concentrating the aqueous extract of dates has total solids content in the range of from about 65% w/w to 85% w/w. For best results, the concentration of the total solid contents in date syrup is maintained up to 75% w/w.

The dates are selected from Khalas, Fard and Barhi, Aabel, Ajwah, Al-Barakeh, Amer Hajj, Abid Rahim, Barakawi, Barhi, Bireir, Datca, Deglet Noor, Derrie, Empress, Fard, Ftimi, Holwah, Haleema, Hayany, Honey, Iteema, Kenta, Khadrawi, Khastawi, Maktoom, Manakbir, Medjool, Migraf, Mgmaget, Mishriq, Mozafati, Nabat-Seyf, Rotab, Sag'ai, Saidy, Sayer, Sukkary, Sellaj, Tagyat, Tamej, Thoory, Umeljwary, Umelkhashab, Zahidi and Zaghloul varieties. In a preferred embodiment, the dates used are selected from Khalas, Fard and Barhi varieties.

The concentrated milk is mixed with the date syrup in an agitated vessel. The mixture is gently mixed at an agitator speed of about 450 RPM. During the mixing operation, the temperature of the vessel is typically raised to a temperature in the range of from about 40° C. to 50° C. The heating of the concentrated milk and date syrup helps to reduce the viscosity of the mixture enabling easy mixing as well as easy spraying into the spray drying chamber. In addition, date syrup is readily soluble in concentrated milk at warmer temperatures.

In another embodiment, the concentrated milk and date syrup are first heated to a temperature in the range of from about 40° C. to 50° C. and then added into an agitated vessel for homogenization.

In yet another embodiment, concentrated milk and date syrup were heated to a temperature ranging from 40° C. to 50° C. with simultaneous stirring in the homogenizing vessel.

The vessel used can be batch or continuous. In a preferred embodiment, the vessel used is a jacketed stainless steel container. Mixing may be carried out using agitators or stirrers. In yet another preferred embodiment, mixing may be carried out using magnetic stirrer. The temperature of the mixture may be measured using a thermometer or a temperature sensor.

During the mixing operation, the homogeneity of the mixture may be continuously monitored using different methods like monitoring by means of optical sensors, sampling the mixture at regular intervals or manually monitoring the color of the mixture. The homogeneity of the mixture is confirmed by the absence of precipitated particles at the bottom of the vessel and in the homogeneous mixture.

The precipitated particles if formed in the homogeneous mixture may be removed by the use of different filtration techniques as well as by centrifugation. These precipitated particles can either be recycled or used as animal feed. The removal of precipitated particles is necessary to prevent clogging of the nozzles during the spray drying process. For an industrial scale production of the homogeneous mixture, it is preferable to use a centrifugation process.

On obtaining a precipitate-free mixture, the mixture is added into the spray dryer using nozzles or atomizers at a predetermined rate. The rate of addition of the homogeneous mixture into the spray dryer, also known as the feed rate, is in the range of from about 3 l/hr to 6 l/hr. In a preferred embodiment, the feed rate is maintained at 4 l/hr.

Different types of spray dryers may be used for spray drying operation like co-current flow type, counter-current flow type, mixed flow type, open cycle type, closed cycle type, semi-closed cycle type, single stage, two stage, horizontal and vertical type spray dryers. For best results, counter current flow type spray dryer is used. In this type of spray dryer, the mixture and the hot air are introduced from the opposite ends of the spray dryer, with an atomizer positioned at the top and the hot air entering from the bottom. The temperature of the air entering the spray dryer is preferably maintained in the range of from about 130° C. to 160° C. For optimum results, the temperature of the spray dryer is maintained at 140° C. This configuration of the spray dryer offers more rapid evaporation and higher energy efficiency.

During the spray drying process, the mixture is exposed to high temperature conditions in the range of from about 130° C. to 160° C. On exposure to such high temperatures, the homogeneous mixture moves from a liquid surface to plastic surface and then forms into a non-sticky (amorphous) surface. Spray drying process results in evaporative cooling which reduces the overall powder temperature.

It is important to control the temperature during the spray drying process. If the product temperature during spray drying is increased beyond the glass transition temperature, the molecular mobility of the molecules in the product increases. Thus, the dried amorphous product formed transforms into rubbery state and then into a viscous state, also known as sticky state. Once an amorphous product transforms into a sticky mass, the product loses its flow characteristics and commercial value. Hence, it is imperative to maintain the temperature of the spray dryer lesser than the Tg of the entire mixture.

For carrying out the invention, the temperature of the spray dryer is optimized at a temperature of 140° C. Further control of the temperature of the spray dryer can be achieved by incorporating different modifications such as:
a) The walls of the spray drying chamber are maintained at a temperature less than the Tg of the mixture,
b) During specific intervals, the product is cooled by the introduction of relatively cool air either from the top or the bottom of the spray dryer, and
c) Special cooling systems like air broom chambers are applied to the spray dryers.

The product obtained from the spray dryer is preferably in the form of a powder, granules or particles. The product can also be agglomerated to form a soluble product in the form of a large granules or flakes.

To obtain the date syrup-milk powder product of the invention, the process conditions are maintained as follows:

Mixture concentration: 45% date solids+55% milk solids
Temperature of the homogenised mixture: 40° C.
Feed rate of the mixture into the spray dryer: 4L/hr
Inlet air temperature of the spray dryer: above 160° C.

The date syrup-milk powder product of the invention may be made more palatable by introducing a distinct caramelized flavor. This caramelized flavor may be due to the Maillard reaction occurring during various stages of the production process, on account of the presence of high level of reducing sugars in the concentrated milk and date syrup and is initialized by the high temperatures present during the spray drying operations. To obtain the desired caramelized flavor, the air temperature of the spray dryer is typically maintained above 140° C. For optimum flavor, the air temperature of the spray dryer is maintained above 160° C.

The date syrup-milk powder product obtained from the spray dryer contains solids from milk and dates. The total solid contents of the concentrated milk and date-dibbs are measured using a refractometer and vacuum oven method.

The total solid content of milk solids in the date syrup-milk powder product is in the range of from about 35% w/w to 75% w/w, and of date solids is in the range of from about 25% w/w to 65% w/w. For better results, the total solid content of milk in the final product is in the range of from about 45% w/w to 65% w/w, and preferably no higher than 55% w/w and the total solid content of dates in the final product is in the range of from about 35% w/w to 55% w/w, preferably no higher than 45% w/w.

The date syrup-milk powder product has a moisture content in the range of from about 1.1% w/w and 2.3% w/w on wet basis, bulk density in the range of from about 220 kg/m³ to 470 kg/m³, tapped density in the range of from about 400 kg/m³ to 600 kg/m³ with an angle of repose 34°-50° and color in the range of L(61-81), a(4-12), b(25-37). The color of the solution can be measured using any standard colorimeter.

### Nutritional Properties of the Product

The date syrup-milk powder product is a 100% natural product and contains nutrients from both milk and dates. The product obtained is a good source of carbohydrates, proteins, vitamins, minerals and trace elements. Advantageously, the process does not require the use of drying aids/agents.

Carbohydrates

The major carbohydrates present in the date syrup-milk powder product are glucose, fructose and lactose in addition to small amount of sucrose and other sugars. Table 1 shows the sugar content of the product.

TABLE 1

| Sugar | g/100 g |
|---|---|
| Lactose | 8-21.6 |
| Glucose | 9-19.7 |
| Fructose | 9-21 |
| Sucrose | 0.1-1.3 |

Proteins

The product contains a high quantity of protein ranging from 12% w/w to 16% w/w.

Minerals

Both milk and dates are rich in minerals and hence the date syrup-milk powder product containing milk and date solids serves as a good source of some required dietary minerals. The mineral content of the date syrup-milk powder product is in the range of from about 650 mg/kg to 12000 mg/kg and consists primarily of calcium, potassium, phosphorus, and magnesium. Other minerals like sodium, sulfur and chloride are also present.

Trace Elements

The trace elements present in the date syrup-milk powder product comprises of iron, zinc, copper, iodine, selenium, manganese, fluoride, chromium and molybdenum. Amongst these, iron, copper, manganese, and zinc are present in comparatively higher quantities.

The mineral and the trace element content of the date syrup-milk powder product are described in table 2.

TABLE 2

| Minerals | mg/kg |
|---|---|
| Potassium | 11000-12000 |
| Calcium | 6100-8900 |
| Phosphorus | 4060-6065 |
| Magnesium | 650-680 |
| Zinc | 18-28 |
| Iron | 6-12.7 |
| Copper | 0.45-0.67 |
| Manganese | 1.0-1.5 |

### Measurements and Calculations

Measuring Total Solids Content

Using a Refractometer

To measure the total solid contents using a refractometer, the following equation is used,

### TS %=0.9984 (Brix %)+2.077; or

### TS %=Brix %+2

Wherein, TS=Total Solids, Brix %=percentage of sugar content of an aqueous solution.

Using Vacuum Oven Method

For measuring the total solid contents using vacuum oven method, according to an official method of analysis, weighed sample is placed under reduced pressure (typically 25-100 mm Hg) in a vacuum oven for a specified time and temperature and the weight of the dried mass is determined. The weight of the dried mass present is measured in terms of total solids percentage (TS %) using the following equation:

$$TS \% = \frac{Weight of the dried mass}{Original weight of the sample} \times 100$$

As the boiling point of water is reduced when it is placed under vacuum, lower temperatures can be used to remove the moisture from the sample thereby preventing the degradation of heat-sensitive samples.

### Advantages

The date syrup-milk powder product provides a natural and healthier alternative to fortified milk products.

The date syrup-milk powder product is made using natural ingredients namely milk and dates. The product has an advantage of not including any additional chemical ingredients. The additional chemical ingredients include sweeteners, emulsifiers, preservatives, stabilizers, mineral salts, food coloring, flavor enhancers, tracer gas and drying agents.

The date syrup-milk powder product obtained is naturally sweet owing to the unique composition of the milk and date solids and can be used as sweeteners for different food and beverage preparations. The use of date syrup-milk powder product of the invention provides for a natural and healthier alternative to artificial sweeteners.

The date syrup-milk powder product of the invention is non-sticky in nature with improved solubility in aqueous medium (including but not limiting to water and milk), flow-characteristics and prolonged shelf life.

Without wishing to be bound by any particular theory, the inventors believe that the free flowing and non-sticky character of the product produced by the method of the invention are due to the following composition and process related modifications:

Composition Related Modifications:

a) High concentration of sugars in dates
Dates are a rich source of sugars. These sugars are in the form of either reducing sugars or disaccharide sugars. The sugars molecules combine with the water molecules forming hydrogen bonds. This interaction reduces the plasticizing effect of water. The bonding of sugars with water and proteins from milk could result in the elevation of the glass transition temperature (Tg) of the mixture. The presence of minerals from the date syrup could have a role as well.
   b) Unique composition of the concentrated milk and the date syrup
The date syrup-milk powder product of the invention contains a combined protein concentration in the range of 14% obtained from milk and dates. Proteins are high molecular weight compounds. They by nature possess a high Tg. The increased protein concentration in the mixture masks the low Tg effect produced by the presence of low molecular weight sugars, thereby increasing the overall Tg of the mixture. Also, the proteins form hydrogen bonding with the water molecules thus reducing the fluidity of the water molecules. Fluidity of the mixture is inversely proportional to the glass transition temperature. Thus, high concentration of proteins helps increasing the Tg of the mixture.

Process Related Modifications:

### a) Concentration of Milk and Aqueous Extract of Dates

Water is an excellent plasticizing agent. Increase in the moisture content, increases the fluidity of the mixture. In the invention, the milk and the aqueous extract of dates is concentrated prior to mixing and spray drying operations. This concentration process helps to decrease the moisture content of the mixture thereby decreasing the fluidity of the mixture and increasing Tg.

### b) Manipulating the Spray Drying Operating Conditions

In a spray dryer, the temperature is maintained in the range of from about 130° C. to 160° C. The temperature is maintained by the use of heat exchangers, temperature controlling jackets or by passing cool air into the spray dryer at regular intervals. By careful control of the operating conditions of the spray dryer as in this embodiment, it is possible to minimize and prevent stickiness problem.
The walls of the spray drying chamber are maintained at a temperature less than the Tg of the mixture. This reduces the chances of the product sticking to the walls of the drying chamber present in the spray dryer. By cooling the product at regular intervals, the temperature of the product is maintained at a temperature lesser than the Tg of the mixture, thereby reducing stickiness. The incorporation of air broom chambers help in scraping the dried materials that are stuck on the walls of the vessel.

The spray drying process in general results in reduced droplets temperature as a result of evaporative cooling leading to a droplet temperature lower than that of the mixture Tg, that will eventually prevent stickiness.

### Applications

The date syrup-milk powder product finds its application in food and beverage products. It may be used by itself or as an additive/constituent in food and/or beverage preparations. A few of the important food/beverage products/preparations wherein the date syrup-milk powder product can find its applications includes dairy products, confectionaries, food coloring, sweeteners, snacks, ready to eat cereals, meals, baked products, canned products, sauces, food dressings, whitener for beverages (including but not limited to coffee), soft drinks, juices, coffee and tea beverages, energy drinks, liqueurs, instant mixes, squashes and mocktails.

The invention will now be described by reference to the following examples which are provided to illustrate, but not to limit, the invention. A preferred embodiment of the invention is described in the following Example, in which the powder is prepared and used as a coffee whitener.

### Example 1

1.1 kg of camel milk with a solid content of 20% w/w was mixed with 0.24 Kg of date syrup with a total solids content of 75% w/w. The mixture was mixed in an agitated vessel and heated to a temperature of 40° C. to obtain a homogenised mixture. This homogenised mixture was then fed into a spray dryer with a feed rate of 5 l/hr. The spray dryer is operated at a temperature of 140° C. The powder is then collected from the bottom of the spray dryer and is stored in a dry and air tight glass container until further use.

Consumer acceptance of the date syrup-milk powder product of the invention was tested against a commercially available coffee whitener, using overall acceptability as a parameter. The overall acceptability parameter comprises different acceptability tests including taste, aroma and color. The product from Example 1 and the commercially available coffee whitener were used with black coffee. These samples were then distributed amongst a random group of people. On evaluation, it was found that 55% of the people preferred the use of the date syrup-milk powder product of the invention in their coffee.

### Example 2

Date syrup-milk powder product was prepared using organic date syrup from Barhi variety and either whole camel milk or whole bovine milk (cow's milk). The milk was concentrated using a rising film evaporator, using an evaporation temperature maintained at 70° C. The protocol described before for the operation of the spray dryer was used in these runs. The powder produced using both milks consisted of 45% w/w date solids and 55% w/w milk solids. Table 3 provides a summary of the physiochemical properties of the produced date syrup-milk powder product:

TABLE 3
Composition and properties of date syrup-milk powder product
prepared using organic date syrup from Barhi variety and
either whole camel milk or whole bovine milk

| | Camel milk- | Cow milk- |
|---|---|---|
| | dibbs powder | dibbs powder |
| Sugars (g/100 g) | | |
| fructose | 17.6 ± 0.43¹ | 18.4 ± 0.23 |
| glucose | 18.8 ± 0.29 | 19.3 ± 0.45 |
| sucrose | 0.26 ± 0.12 | 0.28 ± 0.12 |
| lactose | 20.3 ± 0.37 | 21.6 ± 1.12 |
| mineral (mg/g) | | |
| Ca | 5.2 ± 0.05² | 4.8 ± 0.02 |
| Fe | 0.03 ± 0.02 | 0.03 ± 0.01 |
| K | 10.14 ± 0.19 | 7.8 ± 0.1 |
| Mg | 0.68 ± 0.01 | 0.79 ± 0.004 |
| Na | 3.38 ± 0.06 | 1.57 ± 0.02 |
| P | 4.03 ± 0.04 | 4.04 ± 0.01 |
| % Fat content | 2.51 | 1.35 |
| % protein content | 16.7 | 16.35 |
| Bulk density (kg/m³) | 300 | 280 |
| Taped density (kg/m³) | 450 | 420 |
| Angle of repose | 34° | 36° |
| Insolubility index (ml)³ | Trace³ | Trace³ |
| Moisture content (%) | 1.241 ± 0.1000 | 0.542 ± 0.005 |
| Water activity | 0.237 | 0.260 |

¹Mean ± Standard deviation (HPLC, SOP, column μ-Bondapack NH₂ (300 length × 3.9 id)
²Mean ± SD (inductively coupled plasma ICP-OES, SOP)
³Measured by International Dairy Federation (IDF) (1988) standard- 129A

Date syrup-milk powder was successfully produced using both camel milk and cow milk which indicates reproducibility of the product under the specified operating conditions for both camel and bovine milk. The physiochemical properties reported are within the range of previously generated data, with only a slight variation of the nutrient composition of the powder due to variation in the date syrup which depends on variety. The solubility of the powder is not less than 99%, since only traces of fat were observed on the surface of the centrifuge tube when solubility was tested according to IDF method. The higher solubility is due to the low temperature used in the concentration of the fresh milk used in these runs, which apparently resulted in reduced milk protein denaturation and hence improved solubility.

While the invention has been described in detail and with reference to specific embodiments thereof, it will be apparent to one of skill in the art that various changes and modifications can be made therein without departing from the scope thereof. Moreover, all embodiments described herein are considered to be broadly applicable and combinable with any and all other consistent embodiments, as appropriate.

Various publications are cited herein, the disclosures of which are incorporated by reference in their entireties.

1. A process for preparing a date syrup-milk powder product comprising the steps of mixing concentrated milk and date syrup; and drying the homogenised mixture in a spray dryer.

2. The process according to claim 1 comprising heating the homogenised mixture prior to drying it in a spray dryer.

3. The process according to claim 1 comprising heating the concentrated milk and date syrup prior to mixing.

4. The process according to claim 3 wherein, the heating and mixing operations occur simultaneously.

5. The process according to claim 2 wherein the temperature of the spray dryer is maintained at a temperature lesser than the Tg of the homogenised mixture.

6. The process according to claim 3 wherein, during heating the temperature of the mixture is raised to a temperature in the range of from about 40° C. to 50° C.

7. The process according to claim 1 wherein, the mixture is added into the spray dryer at a feed rate in the range of from about 3 l/hr to 6 l/hr, preferably at a feed rate of 4 l/hr.

8. The process according to claim 1 wherein, the temperature of the spray dryer is maintained in the range of 130° C. to 160° C., preferably at 140° C.

9. The process according to claim 1 wherein, the concentrated milk is obtained by passing the milk through an evaporator.

10. The process according to claim 1 wherein, the concentrated milk contains total solids content in the range of from about 15% to 30% (w/w).

11. The process according to claim 1 wherein, drying occurs without the addition of any drying agent.

12. The process according to claim 11 wherein, the drying agent is selected from a group comprising maltodextrin, starch, gum, corn syrup, liquid glucose and any mixtures thereof.

13. The process according to claim 1 wherein, the date syrup is prepared by concentrating an aqueous extract of dates.

14. The process according to claim 1 wherein, the date syrup has total solids content in the range of 65% to 85% (w/w).

15. The process according to claim 1 wherein, the date syrup-milk powder product contains 35% to 75% (w/w) milk solids and 25% to 65% (w/w) of date solids.

16. A date syrup-milk powder product obtained by a process of claim 1.

17. A date syrup-milk powder product prepared by the steps comprising:
a) concentrating the milk;
b) preparing aqueous extract of dates;
c) concentrating aqueous extract of dates;
d) mixing concentrated milk and date syrup;
e) heating the mixture of concentrated milk and date syrup; and
f) drying the mixture in a spray dryer.

18. The date syrup-milk powder product of claim 17 wherein, the date syrup and milk concentrate is heated prior to mixing.

19. The date syrup-milk powder product of claim 17 wherein, steps (d) and (e) occur simultaneously.

20. A date syrup-milk powder product of natural origin comprising milk solids and date solids.

21. The date syrup-milk powder product of claim 20 wherein, the milk solids is contained in an amount in the range of from about 35% (w/w) to 75% (w/w), preferably 55% (w/w).

22. The date syrup-milk powder product of claim 20 wherein, the date solids is contained in an amount in the range of from about 25% (w/w) to 65% (w/w), preferably 45% (w/w).

23. The date syrup-milk powder product of claim 20 wherein, the product is in the form of a powder, particle or granule.

24. The date syrup-milk powder product of claim 20 wherein, the product further comprises carbohydrates, proteins, vitamins, minerals and trace elements.

25. The date syrup-milk powder product of claim 20 wherein, the product does not contain any additives.

26. The use of the date syrup-milk powder product milk product of claim 20 in food or beverage industries.

27. A food or beverage product comprising the date syrup-milk powder product of claim 20.
